(19) United States
(12) Patent Application Publication
(10) Pub. No.: US 2023/0407582 A1
(43) Pub. Date: Dec. 21, 2023

(54) Roadside Emergency Flag Display

(71) Applicant: Donald Pariga, Goodyear, AZ (US)

(72) Inventor: Donald Pariga, Goodyear, AZ (US)

(21) Appl. No.: 17/841,476

(22) Filed: Jun. 15, 2022

(51) Int. Cl. E01F 9/692; E01F 9/619; E01F 9/627; G09F 13/16

(52) U.S. Cl. CPC E01F 9/692; E01F 9/619; E01F 9/629; G09F 13/16

(57) ABSTRACT

The warning “flag” stand is the only product of its kind that stands at a high height on the road and comes in a set of six to fully define the area of an emergency setting. The warning “flag” stand is uniquely designed with indestructible and durable materials to ensure long-term sustainability. Moreover, the warning “flag” stand is carefully crafted with a double-sided reflective foldable triangle and mesh supporting system to guarantee the sign is visible from far distances, angles and terrains.

### BACKGROUND

When a vehicle breaks down on the side of the road, in the middle of the highway, or even on a city street, warning devices are essential to inform other motorists on the road of potential car/person presence and/or to help prevent another traffic accident situation from occurring that would heighten the emergency. Current products available on the market today, however, often get destroyed easily, can sometimes be ineffective, and are difficult for motorists to see due to their material and size. There have been no products available as original equipment or as an aftermarket to address this problem.

An apparatus that is simple to use yet effective to see and to warn other motorists of a broken down vehicle is not being met by any known device or system at present. There have been no products available as original equipment or as an aftermarket to address this problem either.

### SUMMARY OF THE INVENTION

The main purpose of roadside emergency flag display is to provide users with an improved reflective warning device for broken down vehicles and other emergency situations on the road.

The disclosure includes a telescoping pole comprising a bottom end and a top end and a plurality of telescoping sections there between. The disclosure also includes a base comprising a plurality of legs each hingedly joined to the telescoping pole bottom end via a respective hinge. The disclosure yet includes a flag comprising a foldable frame joined to the telescoping pole via a flag hinge.

### BRIEF DESCRIPTION OF THE DRAWINGS

FIG. 1 is a front perspective view of the roadside emergency flag display in accordance with an embodiment of the present disclosure.

FIG. 2 is a front elevational view of the roadside emergency flag display in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

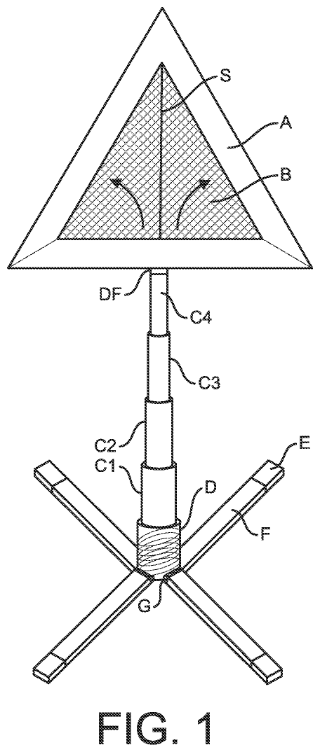

FIG. 1 is a front perspective view of the roadside emergency flag display showing: reflective (from both sides) foldable triangle frame referenced as A, mesh referenced as B, reflective flexible pole referenced as C, spring loaded pole holder referenced as D, rubber ends referenced as E, folding base referenced as F, hinges referenced as G, telescoping or reflexive pole sections C1, C2, C3 and C4, the flag hinge DF, and the seam or folding hinge S in accordance with an embodiment of the present disclosure.

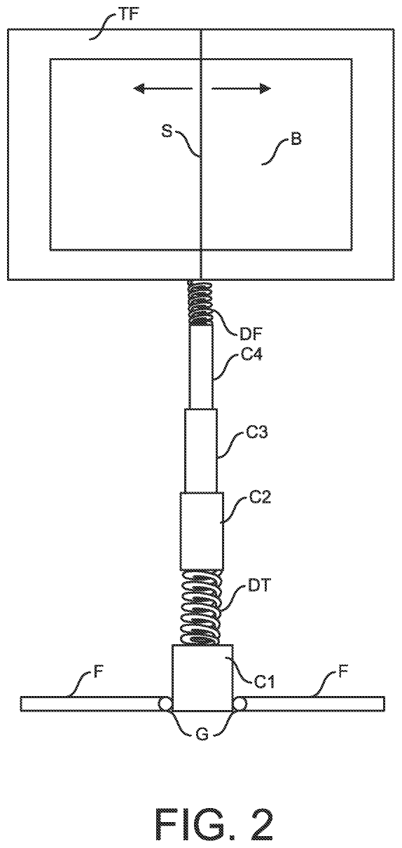

FIG. 2 is a front elevational view of the roadside emergency flag display showing same and similar limitations as those of FIG. 1 with the addition of a rectangular folding frame and flag and a spring replacing one section of the telescoping pole DT and the flag hinge DF implemented as a second spring. Though not depicted due to the elevational view thereof, a number of folding legs hingedly joined to the base and comprising the base are 3, 4 and 5 depending on wind restraint and wind relief required.

The present disclosed roadside emergency flag display, also known as the “Warning ‘Flag’ Stand” offers a modern accessory that ensures users are able to effectively and clearly notify upcoming vehicles about their situation; thus, allowing for a safer experience for other travelers on the road in addition to the individuals involved in a pending automotive dilemma, themselves. While normal warning triangles are heavy, breakable and only come in sets of three, the warning “flag” stand device comes in a primary set of six and can be deployed by the driver with minimal physical labor and effort. Furthermore, unlike today's products which sit on the ground at only about a foot high, the warning “flag” stand introduces a novel fiberglass stand possessing a metal four leg base that sits at approximately two to three feet high to ensure other drivers on the road can clearly see the warning sign positioned. To further enhance functionality, the double-sided reflective foldable triangle frame is placed on an indestructible sturdy base to guarantee the platform is securely planted on the ground. The warning “flag” stand ensures a fully operational warning device that is specifically designed to alert oncoming traffic about an emergency situation on the road.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A roadside emergency flag comprising:
a telescoping pole comprising a bottom end and a top end and a plurality of telescoping sections there between;
a base comprising a plurality of legs each hingedly joined to the telescoping pole bottom end via a respective hinge; and
a flag comprising a foldable frame joined to the telescoping pole via a flag hinge.

2. The roadside emergency flag of claim 1 further comprising a base spring proximal the bottom end of the telescoping pole configured as a wind relief.

3. The roadside emergency flag of claim 1, further comprising a telescoping pole spring configured to replace one of the plurality of telescoping sections.

4. The roadside emergency flag of claim 1, wherein the base springs are limited to a 90 degree travel to rest parallel to and against the telescoping pole.

5. The roadside emergency flag of claim 1, wherein the flag hinge is a spring configured to replace one of the plurality of telescoping sections.

6. The roadside emergency flag of claim 1, wherein the flag spring is proximal the top end of the telescoping pole.

7. The roadside emergency flag of claim 1, wherein the foldable frame comprises a folding hinge.

8. The roadside emergency flag of claim 1, wherein the foldable frame comprises a seam.

9. The roadside emergency flag of claim 1, wherein the flag comprises a reflective mesh on a front side and on a back side of the flag.

10. The roadside emergency flag of claim 1, wherein the foldable frame comprises a reflective coating on a front side and on a back side of the foldable frame.

11. The roadside emergency flag of claim 1, wherein the flag is in a triangular geometry.

12. The roadside emergency flag of claim 1, wherein the flag is in a polygonal geometry.

13. The roadside emergency flag of claim 1, wherein the flag is circular.

14. The roadside emergency flag of claim 1, wherein each of the plurality of legs comprise a rubber end.

15. The roadside emergency flag of claim 1, wherein a number of the plurality of legs is 4.
